(19) United States
(12) Patent Application Publication
(10) Pub. No.: US 2011/0187133 A1
(43) Pub. Date: Aug. 4, 2011

(54) BATTERY COVER LATCH MECHANISM AND PORTABLE ELECTRONIC DEVICE USING THE SAME

(75) Inventor: SHUI-JIN DONG, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/778,759

(22) Filed: May 12, 2010

(30) Foreign Application Priority Data
Feb. 4, 2010 (CN) 201010301199.3

(51) Int. Cl. E05B 63/20

(52) U.S. Cl. 292/334

(57) ABSTRACT

A battery cover latching mechanism includes a housing member, a cover member, and a latching member. The latching member is assembled with the cover member and includes a latching clasp and a resilient arm. The latching clasp selectively latches and unlatches from the housing member by deforming the resilient arm.

### BACKGROUND

1. Technical Field

The present disclosure relates to battery cover latch mechanisms used in portable electronic devices.

2. Description of Related Art

Portable electronic devices usually include latch mechanisms to latch battery covers to housings. The latch mechanisms are required to allow frequent installation and removal of batteries.

A typical latch mechanism includes a pair of hooks at one end of the battery cover and a locking pin protruding from the other end of the battery cover. The housing defines a pair of grooves and a locking hole. In assembly, the hooks are inserted into the grooves. The battery cover is pressed down to the housing until the locking pin is inserted into the locking hole. However, during disassembly, a large force is needed to remove the battery cover from the housing. Therefore, it can be inconvenient to install or remove a battery.

Therefore, there is room for improvement within the art.

### BRIEF DESCRIPTION OF THE DRAWINGS

Many aspects of the battery cover latch mechanism and portable electronic device using the battery cover latch mechanism can be better understood with reference to the following drawings. The components in the drawings are not necessarily drawn to scale, the emphasis instead being placed upon clearly illustrating the principles of battery cover latch mechanism and portable electronic device using the battery cover latch mechanism.

FIG. 1 is a schematic view of a portable electronic device using a battery cover latching mechanism, according to an exemplary embodiment.

FIG. 2 is an exploded view of the battery cover latching mechanism shown in FIG. 1.

FIG. 3 is similar to FIG. 2, but shown from another aspect.

FIG. 4 is a partially assembled view of the portable electronic device.

FIG. 5 is similar to FIG. 4, but shown from another aspect.

### DETAILED DESCRIPTION

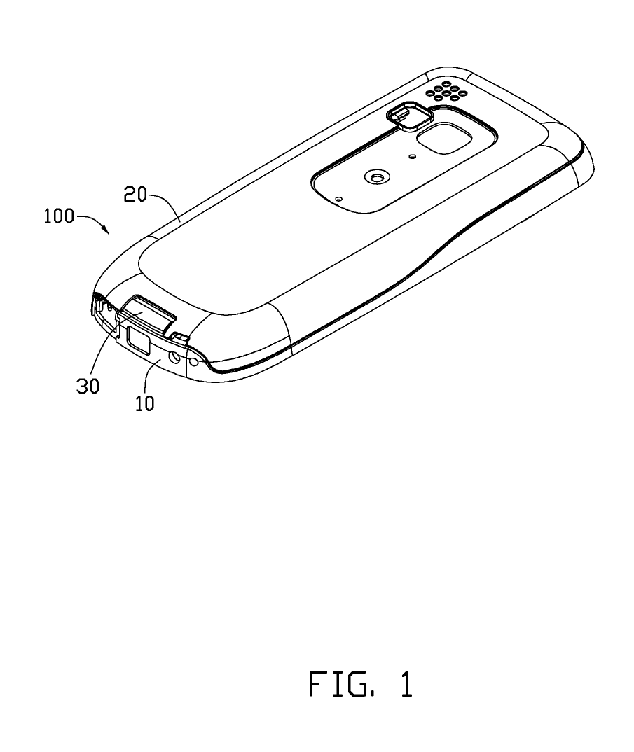

FIG. 1 shows a battery cover latch mechanism 100 used in a portable electronic device, here, a mobile phone. The battery cover latch mechanism 100 includes a housing member 10, a cover member 20, and a latching member 30. The housing member 10 can be a housing of the portable electronic device. The cover member 20 can be a battery cover of the portable electronic device. The latching member 30 is slidably mounted between the housing member 10 and the cover member 20, providing latching and unlatching of the cover member 20 relative to the housing member 10.

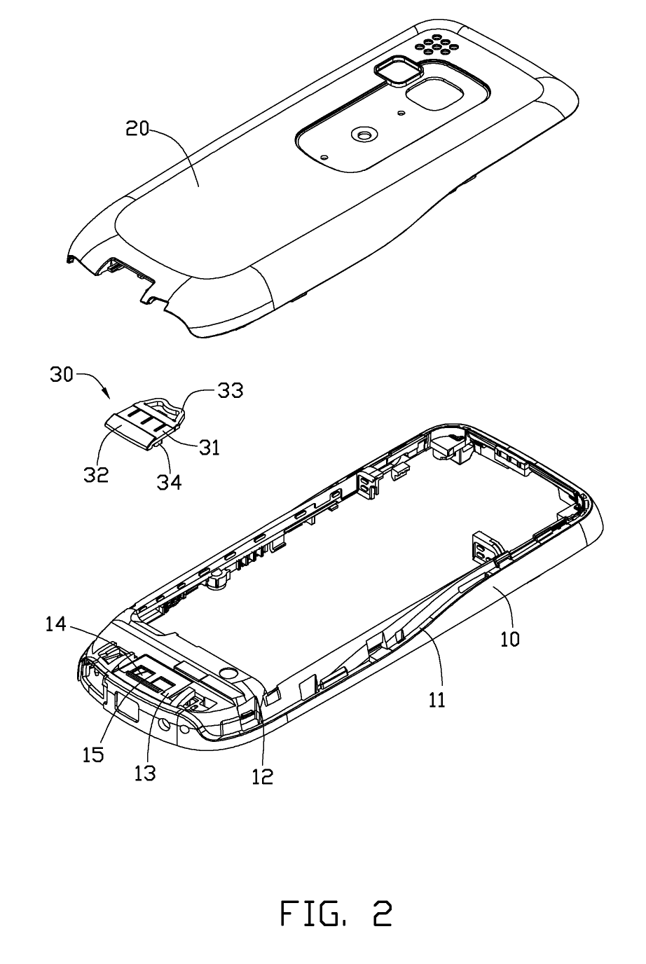

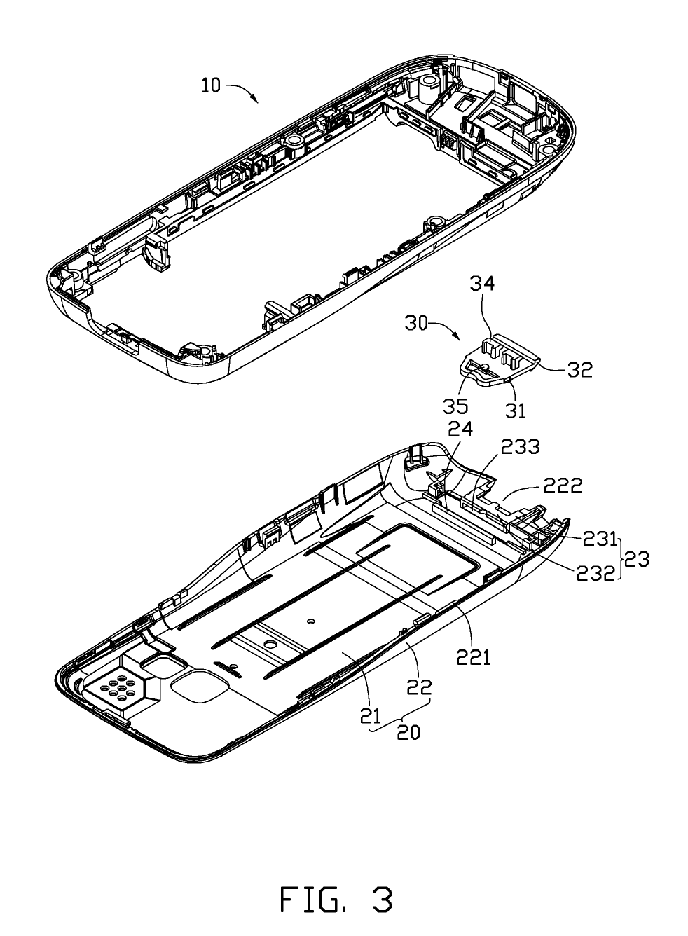

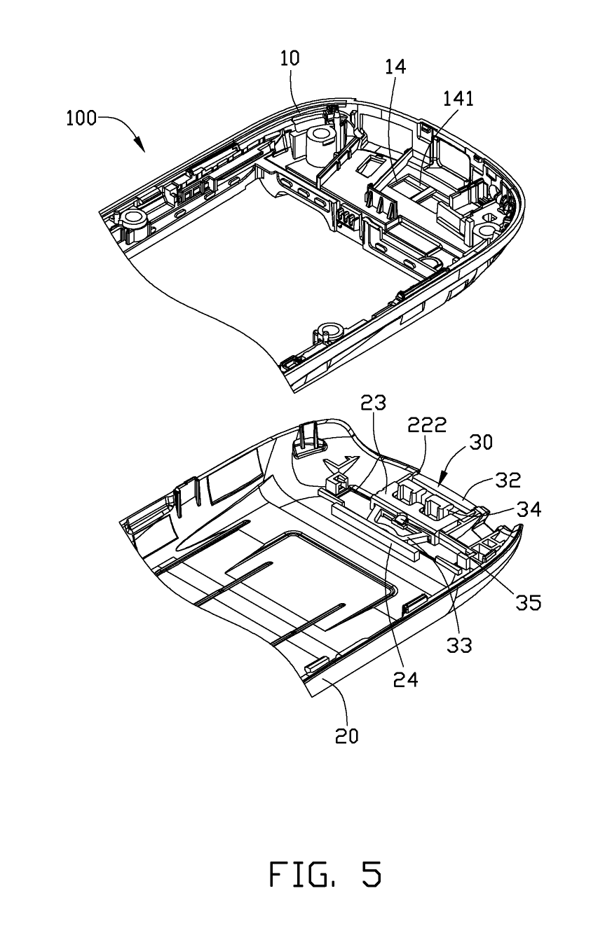

Referring to FIGS. 2 and 3, the housing member 10 is substantially a rectangular frame. The exterior edge of the housing member 10 is recessed to form a step-like mounting edge 11. A protruding block 12 is disposed at one end of the housing member 10. A generally rectangular planar surface 13 is formed in the protruding block 12. Two latching holes 14 are defined in the surface 13 through the protruding block 12. A latching surface 141 (best shown in FIG. 5) extends from one side of each latching hole 14. A tab 15 protrudes from the surface 13 at one side of the two latching holes 14.

The cover member 20 includes a bottom wall 21 and a peripheral wall 22 extending around the peripheral edge of the bottom wall 31. A mounting portion 23 is disposed at one end of the bottom wall 21 to assembly the latching member 30, corresponding to the protruding block 12. The mounting portion 23 includes two opposite side walls 231 and a connecting arm 232. The two side walls 231 protrude from the bottom wall 21. The connecting arm 232 perpendicularly connects one end of each side wall 231 and forms an opening 233 with the bottom wall 21 therebetween. A resisting bar 24 is disposed at the bottom wall 21 and is substantially parallel to and spaced from the connecting arm 232. A matching edge 221 protrudes from edges of peripheral wall 22 and mates with the mounting edge 11 of the housing member 10. The peripheral wall 22 defines a notch 222 in one end thereof to partially receive the latching member 30.

The latching member 30 includes a main portion 31, a contact panel 32, a curled resilient arm 33, two latching clasps 34 and a fixed stopper 35. The main portion 31 is generally a rectangular sheet. The contact panel 32 is disposed at one side of the main portion 31 and corresponds to the notch 222 of the cover member 20. The resilient arm 33 is disposed at another side of the main portion 31 and is opposite to the contact panel 32. The two latching clasps 34 protrude from one surface of the main portion 31 facing the housing member 10, and are configured to engage in the latching holes 14. The fixed stopper 35 protrudes from one edge of the main portion 31 opposite to the contact panel 32 and coplanar with the latching clasps 34.

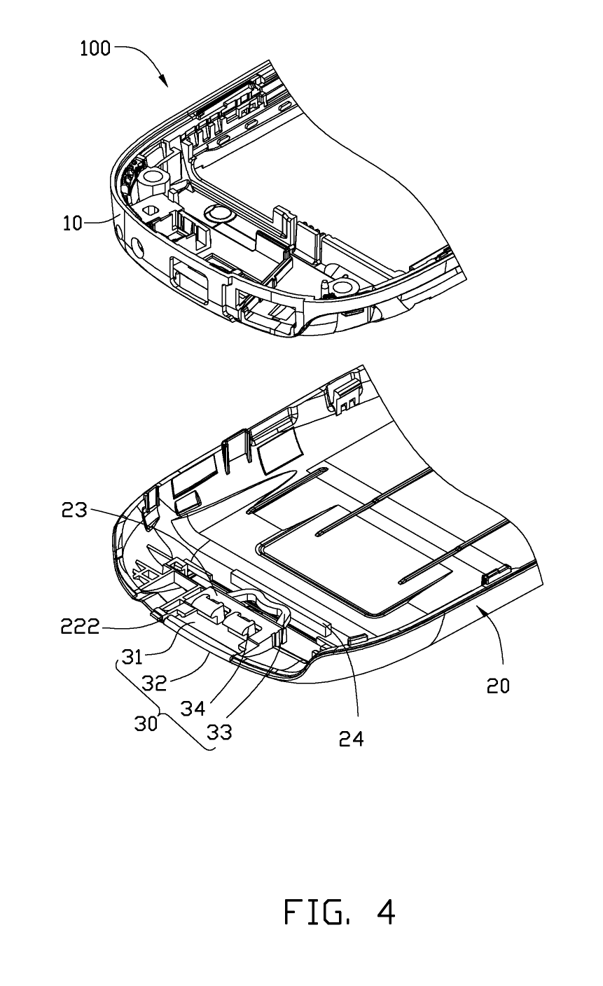

Referring to FIGS. 4 and 5, to assemble the battery cover latch mechanism 100, the latching member 30 is slidably assembled into the mounting portion 23. The resilient arm 33 extends through the opening 233 and abuts against the resisting arm 33. The fixed stopper 35 passes through the opening 233 and resists at one side of the connecting arm 232. Then, the matching edge 221 of the cover member 20 is aligned with and engages with the mounting edge 11 of the housing member 10. Simultaneously, the contact panel 32 is pressed toward another end of the housing member 10. The resilient arm 35 resists against the resilient bar 24, and is elastically deformed. The main portion 31 of the latching member 30 slides along the opening 233. Each latching clasps 34 slides along the tab 15 and engages in the corresponding latching hole 14. Finally, when the latching member 30 is released, it returns to its original position by the force of the resilient arm 31. The latching clasps 34 latch to the latching surfaces 141. Thus, the cover member 20 is latched to the housing 10.

To remove the cover member 20 from the housing member 10, the contact panel 32 is pressed to slide it further into the notch 222. During this stage, the resisting bar 24 deforms the resilient arm 33. Simultaneously, the latching clasps 34 separate from the latching surfaces 141 of the housing member 10. Then, the cover member 20 can be easily detached from the housing member 10 by removal of the latching clasps 34 from the latching holes 14. After release of the contact panel 31, the deformed resilient arm 35 returns to its relaxed state.

The cover member 30 can be attached/detached from the housing member 10 by the operation of the battery cover latch mechanism 100, which is simple in structure and easy to operate.

It is believed that the exemplary embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A battery cover latching mechanism, comprising:
a housing member;
a cover member; and
a latching member assembled with the cover member and including a latching clasp and a resilient arm; wherein the latching clasp selectively latches and unlatches from the housing member by deforming the resilient arm.

2. The battery cover latching mechanism as claimed in claim 1, wherein the latching member further includes a main portion and a contact panel, the contact panel and the resilient arm are respectively disposed at opposite sides of the main portion, the latching clasp protrudes from one surface of the main portion and facing the housing member.

3. The battery cover latching mechanism as claimed in claim 1, wherein the cover member includes a bottom wall and a peripheral wall extending around the peripheral edge of the bottom wall, a mounting portion is disposed at the bottom wall to assemble the latching member.

4. The battery cover latching mechanism as claimed in claim 3, wherein the mounting portion includes two opposite side walls protruding from the bottom wall and a connecting arm connecting the two side walls, the connecting arm forms an opening with the bottom wall therebetween, a resisting bar is disposed at the bottom wall, and parallel to and spaced from the connecting arm, the resilient arm extends through the opening and abuts the resisting arm.

5. The battery cover latching mechanism as claimed in claim 3, wherein the latching member further includes a fixed stopper protruding from one edge of the main portion opposite to the contact panel and coplanar with the latching clasp, the fixed stopper passes through the opening and resists at one side of the connecting arm.

6. The battery cover latching mechanism as claimed in claim 3, wherein the peripheral wall defines a notch in one end thereof to partially receive the latching member.

7. The battery cover latching mechanism as claimed in claim 1, wherein the housing member defined at least one latching hole therein, a latching surface extends from one side of the latching hole, the latching clasp passes through the latching hole and latch to the latching surface.

8. The battery cover latching mechanism as claimed in claim 7, wherein the housing member includes a tab disposing at one side of the latching hole.

9. A portable electronic device, comprising:
a housing;
a battery cover; and
a latching member assembled with the cover member and including a latching clasp and a resilient arm; wherein the latching clasp selectively latches and unlatches from the housing member by deforming the resilient arm.

10. The portable electronic device as claimed in claim 9, wherein the latching member further includes a main portion and a contact panel, the contact panel and the resilient arm are respectively disposed at opposite sides of the main portion, the latching clasp protrudes from one surface of the main portion and facing the housing member.

11. The portable electronic device as claimed in claim 9, wherein the cover member includes a bottom wall and a peripheral wall extending around the peripheral edge of the bottom wall, a mounting portion is disposed at the bottom wall to assemble the latching member.

12. The portable electronic device as claimed in claim 11, wherein the mounting portion includes two opposite side walls protruding from the bottom wall and a connecting arm connecting the two side walls, the connecting arm forms an opening with the bottom wall therebetween, a resisting bar is disposed at the bottom wall, and parallel to and spaced from the connecting arm, the resilient arm extends through the opening and abuts the resisting arm.

13. The portable electronic device as claimed in claim 11, wherein the latching member further includes a fixed stopper protruding from one edge of the main portion opposite to the contact panel and coplanar with the latching clasp, the fixed stopper passes through the opening and resists at one side of the connecting arm.

14. The portable electronic device as claimed in claim 11, wherein the peripheral wall defines a notch in one end thereof to partially receive the latching member.

15. The portable electronic device as claimed in claim 9, wherein the housing member defined at least one latching hole therein, a latching surface extends from one side of the latching hole, the latching clasp passes through the latching hole and latch to the latching surface.

16. The portable electronic device as claimed in claim 15, wherein the housing member includes a tab disposing at one side of the latching hole.

17. A battery cover latching mechanism, comprising:
a housing member defining at least one latching hole;
a cover member including a mounting portion;
a latching member assembled with the cover member and including a latching clasp and a resilient arm; wherein the latching clasp selectively engages in and unlatches the latching hole by deforming the resilient arm.
